(19) United States
(12) Patent Application Publication
(10) Pub. No.: US 2026/0322008 A1
(43) Pub. Date: Oct. 15, 2026

(54) PIN-LESS CONNECTOR FOR HIGH SPEED I/O MATING

(71) Applicant: Cisco Technology, Inc., San Jose, CA (US)

(72) Inventors: Amendra Koul, San Francisco, CA (US); David Nozadze, San Jose, CA (US); Sayed Ashraf Mamun, San Jose, CA (US); Mike Sapozhnikov, San Jose, CA (US); D. Brice Achkir, Livermore, CA (US)

(21) Appl. No.: 19/177,724

(22) Filed: Apr. 14, 2025

(51) Int. Cl. H01R 12/72; H01R 13/22; H01R 43/26

(52) U.S. Cl. CPC H01R 12/722; H01R 13/22; H01R 43/26

(57) ABSTRACT

A pin-less connector for high speed I/O mating includes a first connector portion having a first printed circuit board (PCB) including first electrical contacts, a second connector portion having a second PCB including second electrical contacts in an arrangement corresponding to an arrangement of the first electrical contacts, and an elastomer interposer disposed between the first PCB and the second PCB, the elastomer interposer including electrically conductive particles dispersed therein that electrically connect the first electrical contacts to the second electrical contacts.

### TECHNICAL FIELD

The present disclosure relates to a connector for high-speed input/output (I/O) electrical connections.

### BACKGROUND

Electrical connectors are used to enable electrical components to communicate with one another. Electrical connectors can also be used along an electrical path between electrical devices to connect cables to other cables or to printed circuit boards (PCBs). A connector may be thought of as having two portions: a first portion which connects to a first electrical device or a first cable and a second portion which connects to a second electrical device or a second cable, to be put into communication with the first device or first cable. To connect the two electrical devices or cables, the first and second portions of the connector are mechanically and electrically mated together.

Switches and routers typically include a plurality of ports in communication with optical and/or electrical cables via electrical connectors. Similarly, line cards are connected to network back plane or fabric components via electrical connectors. Notably, as the speed or bit rate of electrical communication via these connectors increases, signal integrity (SI) may be detrimentally impacted due to, among other things, crosstalk caused by exposed metal pins and/or discontinuities between mating electrical components in the electrical connectors.

### BRIEF DESCRIPTION OF THE DRAWINGS

FIG. 1 is a partial exploded view of female and male components of a Quad Small Form-factor Pluggable double density (QSFP-DD) pin-less connector according to an example embodiment.

FIG. 2 is a diagram showing an elastomer interposer disposed between connection PCBs of the female and male components of the QSFP-DD pin-less connector according to an example embodiment.

FIG. 3 is a cross-sectional view showing the elastomer interposer sandwiched under pressure between connection PCBs of the QSFP-DD pin-less connector according to an example embodiment.

FIG. 4 is a diagram showing mated female and male components of the QSFP-DD pin-less connector according to an example embodiment.

FIG. 5 shows a perspective view of the mated female and male components of the QSFP-DD pin-less connector according to an example embodiment.

FIG. 6 is a partial exploded view of female and male components of a QSFP-DD Fiber Optic transceiver pin-less connector according to an example embodiment.

FIG. 7 is a diagram showing an elastomer interposer disposed between connection PCBs of female and male components of the QSFP-DD Fiber Optic transceiver pin-less connector according to an example embodiment.

FIG. 8 is a diagram showing mated female and male components of the QSFP-DD Fiber Optic transceiver pin-less connector according to an example embodiment.

FIGS. 9 and 10 show the use of a pin-less connector to connect a line card with a fabric card according to an example embodiment.

FIG. 11 shows the use of a pin-less connector to connect a line card with a fabric card where the line card employs PCB traces to connect an application specific integrated circuit (ASIC) to a component of the pin-less connector according to an example embodiment.

FIG. 12 shows the use of a pin-less connector to connect a line card with a fabric card where the line card employs cabling and associated connectors to connect an ASIC to a component of the pin-less connector according to an example embodiment.

FIG. 13 shows a pin-less connector having off-angle mating faces according to an example embodiment.

FIG. 14 is a flowchart depicting a series of operations to connect electrical components using a pin-less connector according to an example embodiment.

FIG. 15 is a block diagram of a computing device that may make use of the pin-less connector according to an example embodiment.

### DETAILED DESCRIPTION

### Overview

A pin-less connector for high speed I/O mating is described and includes a first connector portion having a first printed circuit board (PCB) including first electrical contacts, a second connector portion having a second PCB including second electrical contacts in an arrangement corresponding to an arrangement of the first electrical contacts, and an elastomer interposer disposed between the first PCB and the second PCB, the elastomer interposer including electrically conductive particles dispersed therein that electrically connect the first electrical contacts to the second electrical contacts.

A pin-less connector for high speed I/O mating may also include a first connector portion having a first set of pin-less electrical contacts, a second connector portion configured to mate with the first connector portion and having a second set of pin-less electrical contacts in an arrangement corresponding to an arrangement of the first set of pin-less electrical contacts, and an elastomer interposer configured to be compressed between the first set of pin-less electrical contacts and the second set of pin-less electrical contacts, the elastomer interposer including electrically conductive particles dispersed therein that establish electrical connection between the first set of pin-less electrical contacts and the second set of pin-less electrical contacts.

A method for mating a first connector portion and a second connector portion is described. The method includes moving a first connector portion having a first printed circuit board (PCB) including first electrical contacts towards a second connector portion having a second PCB including second electrical contacts corresponding to the first electrical contacts, and sandwiching an elastomer interposer, including electrically conductive particles dispersed therein, between the first PCB and the second PCB such that the electrically conductive particles electrically connect the first electrical contacts to the second electrical contacts.

### Example Embodiments

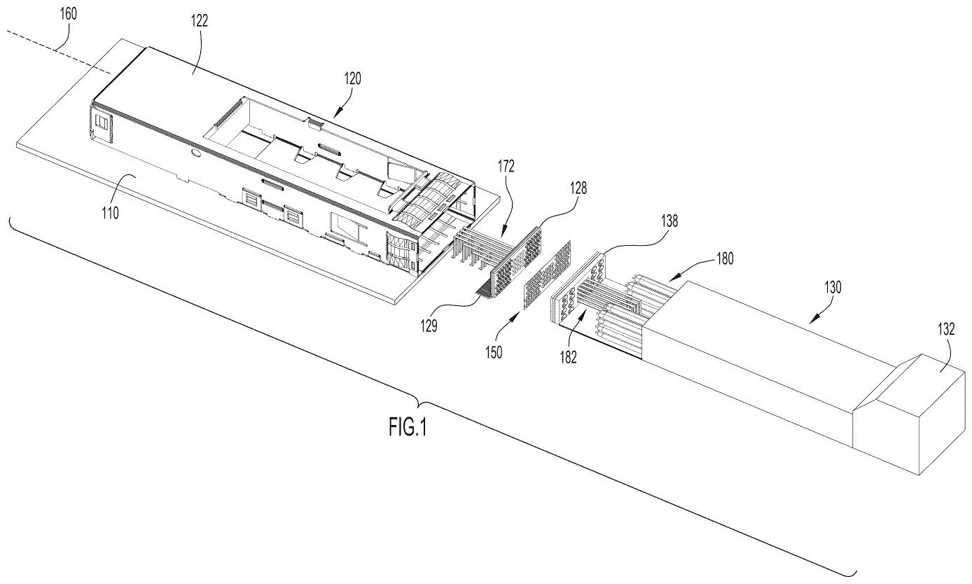

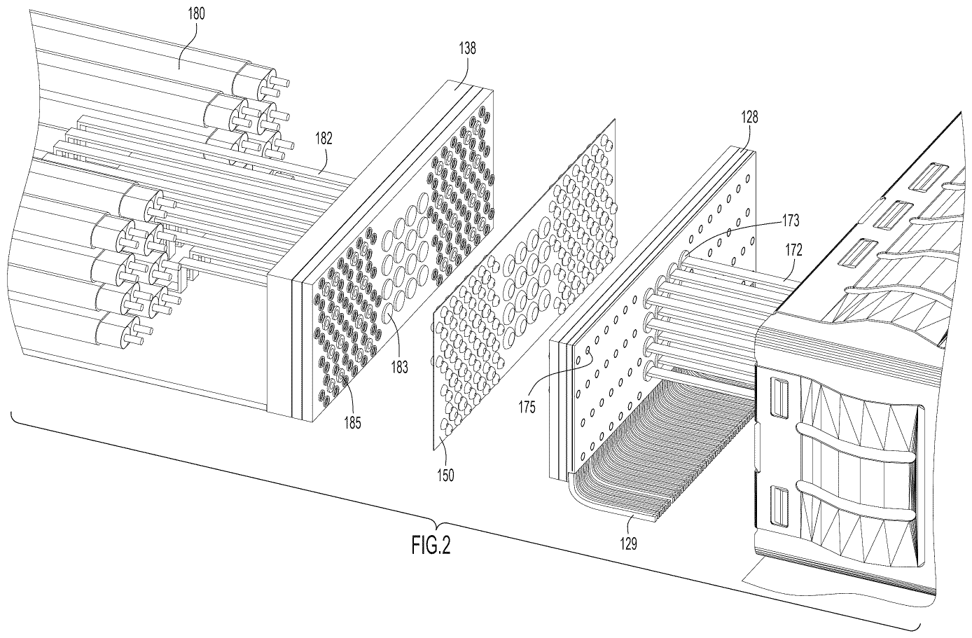

Reference is first made to FIGS. 1 and 2. FIG. 1 is a partial exploded view of female and male components of a Quad Small Form-factor Pluggable double density (QSFP-DD) pin-less connector according to an example embodiment and FIG. 2 is a diagram showing an elastomer interposer 150 disposed between connection PCBs of the female and male components of the QSFP-DD pin-less connector. Although described in connection with a QSFP-DD connector in these initial figures, those skilled in the art will appreciate that the embodiments described herein, including in connection with other figures, are applicable to virtually any connector that enables connecting power and/or communication signals between devices.

Referring to FIGS. 1 and 2, a first connector portion 120 corresponds to a metal cage 122 or female component of a QSFP-DD connector. First connector portion 120 is mounted to a printed circuit board (PCB) 110, which may be mounted in a chassis (not shown). A second connector portion 130 corresponds to an insert, male component, or plug of the QSFP-DD connector and is configured to mate with first connector portion 120 by inserting second connector portion 130 along a travel axis 160 into first connector portion 120. Second connector portion 130 includes a connector cage 132 that is configured to receive a cable connector.

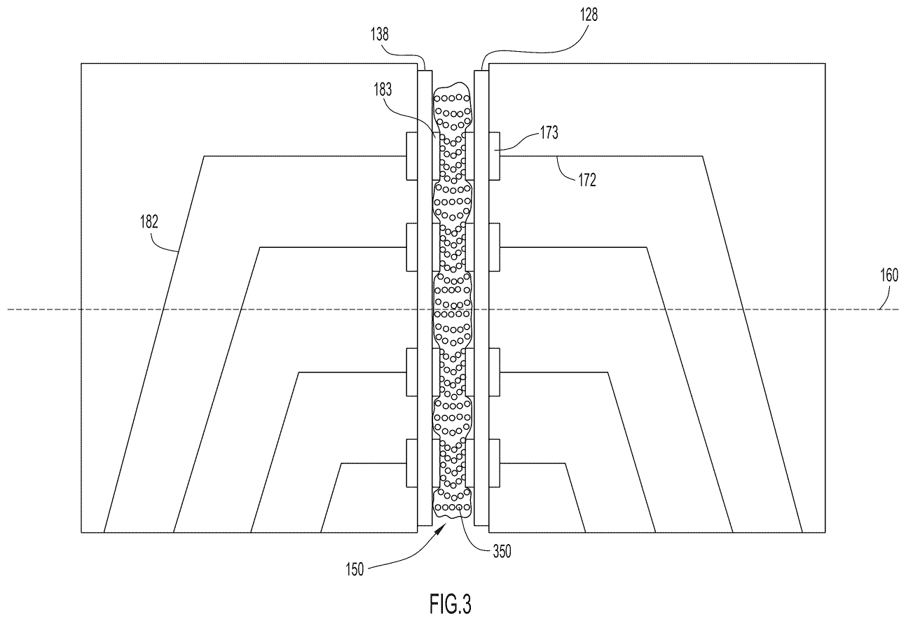

First connector portion 120 further includes a cage-side connection PCB 128 and second connector portion 130 includes a plug-side connection PCB 138. An elastomer interposer 150, including electrically conductive particles 350 dispersed therein (shown in more detail in FIG. 3), is disposed between cage-side connection PCB 128 and plug-side connection PCB 138.

Cage-side connection PCB 128 includes power pins 172 that terminate at power electrical contacts 173, and a flexible PCB 129, which is in electrical communication with PCB 110, supplies I/O signals to/from I/O electrical contacts 175. Power electrical contacts 173 and I/O electrical contacts 175 may extend through cage-side connection PCB 128 with vias (not shown) and present as solder balls or metal exposed surfaces or pads on a side of cage-side connection PCB 128 facing elastomer interposer 150.

Plug-side connection PCB 138 includes power pins 182 that terminate at power electrical contacts 183. I/O cables 180 supply I/O signals to/from I/O electrical contacts 185. Power electrical contacts 183 and I/O electrical contacts 185 may be solder balls or metal exposed surfaces or pads on a side of plug-side connection PCB 138 facing elastomer interposer 150, and vias (not shown) may connect those solder balls or metal pads to the power electrical contacts 183 and I/O electrical contacts 185.

In FIG. 2, elastomer interposer 150 is shown having residual impressions left by power electrical contacts 173, 183 and I/O electrical contacts 175, 185, after being sandwiched between the cage-side connection PCB 128 and the plug-side connection PCB 138.

More specifically, FIG. 3 shows elastomer interposer 150 sandwiched under pressure between connection PCBs of the pin-less connector according to an example embodiment. In an embodiment, elastomer interposer 150 is made from a flexible material such a rubber, silicone, etc., and includes a plurality of electrically conductive particles 350 suspended in the material. When not under compressive pressure, the electrically conductive particles 350 are not in contact with one another, effectively making elastomer interposer 150 an electric insulator. However, once elastomer interposer 150 is disposed or sandwiched between plug-side connection PCB 138 and cage-side connection PCB 128, and particularly, e.g., power electrical contacts 173, 183 (as shown) and I/O electrical contacts 175, 185 (not shown in FIG. 3), the elastomeric material is compressed in those specific areas causing the elastomeric material to break down and enable electrically conductive particles 350 to contact each other, resulting in an electrical connection between power electrical contacts 173, 183 (as shown) and I/O electrical contacts 175, 185. Portions of elastomer interposer 150 not directly sandwiched between power electrical contacts 173, 183 (as shown) or I/O electrical contacts 175, 185 remain non-conductive as the electrically conductive particles 350 in those portions are not forced to contact one another.

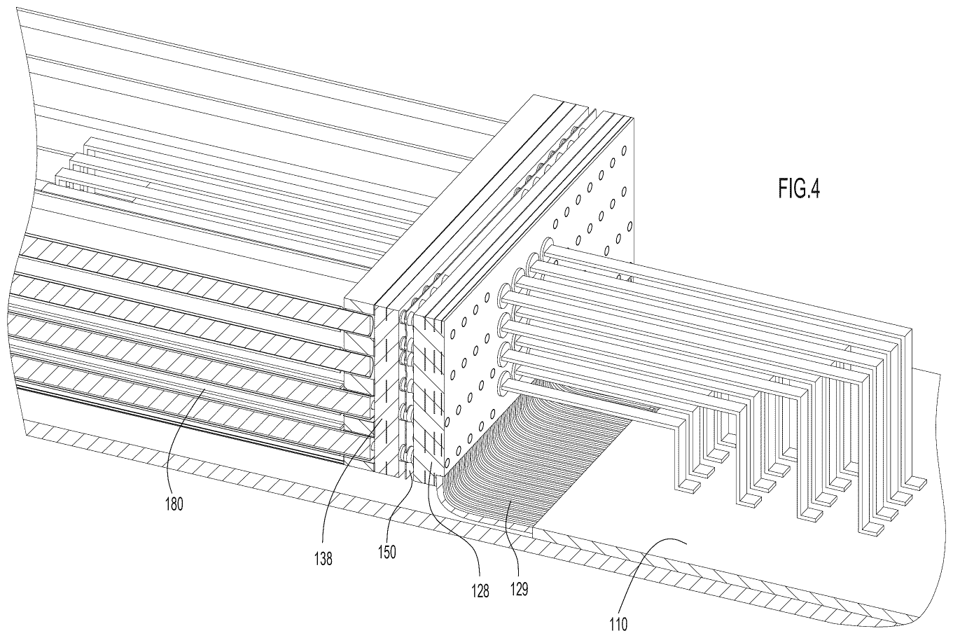

Notably, plug-side connection PCB 138 and cage-side connection PCB 128 are perpendicular to the travel axis 160 so that parallel planes of their opposing surfaces come together as shown in FIG. 3. In this regard, FIG. 4 shows the mated female and male components of the QSFP-DD pin-less connector according to an example embodiment. Although not expressly shown, and as indicated above, vias may be provided to connect power electrical contacts 173, 183 or I/O electrical contacts 175, 185 to opposing surfaces of plug-side connection PCB 138 and cage-side connection PCB 128, respectively.

Also shown in FIG. 4 is the use of flexible PCB 129 to connect, e.g., I/O electrical contacts 175 of cage-side connection PCB 128 to PCB 110. Flexible PCB 129 enables the cage-side connection PCB 128 to be angled, e.g., 90 degrees, with respect to PCB 110 and thus properly face plug-side connection PCB 138 to achieve proper mating and sandwiching of elastomer interposer 150 between the opposing PCBs and electrical contacts.

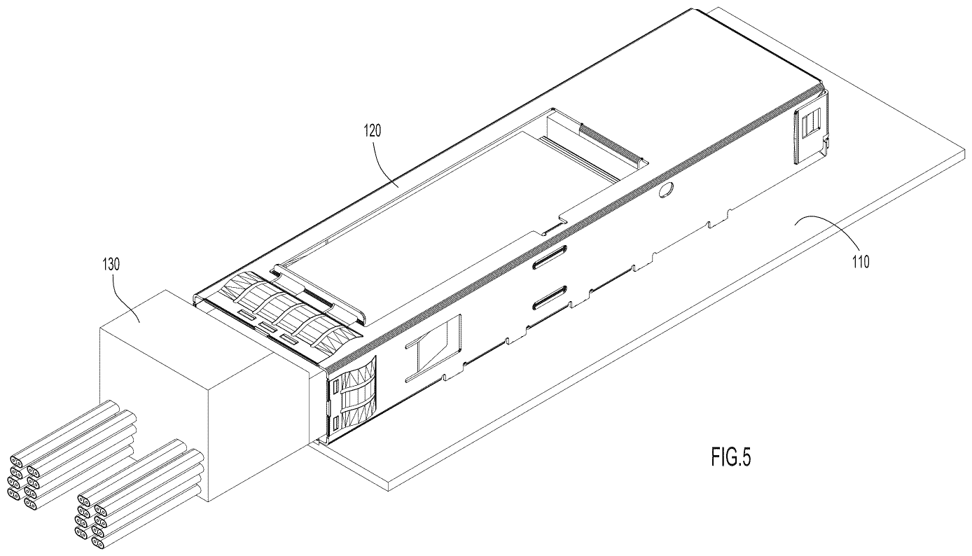

FIG. 5 shows a perspective view of the mated female and male components of the QSFP-DD pin-less connector according to an example embodiment. Specifically, this figure shows a non-exploded fully mated view of the pin-less connector including first connector portion 120 attached to PCB 110 and second connector portion 130 mated inside first connector portion 120.

As those skilled in the art will appreciate, the pin-less connector configuration shown in FIGS. 1-5 eliminates traditional pin/socket or pin/land contacts. As such, there are fewer sharp edged metal structures that can detrimentally act as antennas/radiators and cause spurious transmissions that can increase channel crosstalk and reduce signal integrity.

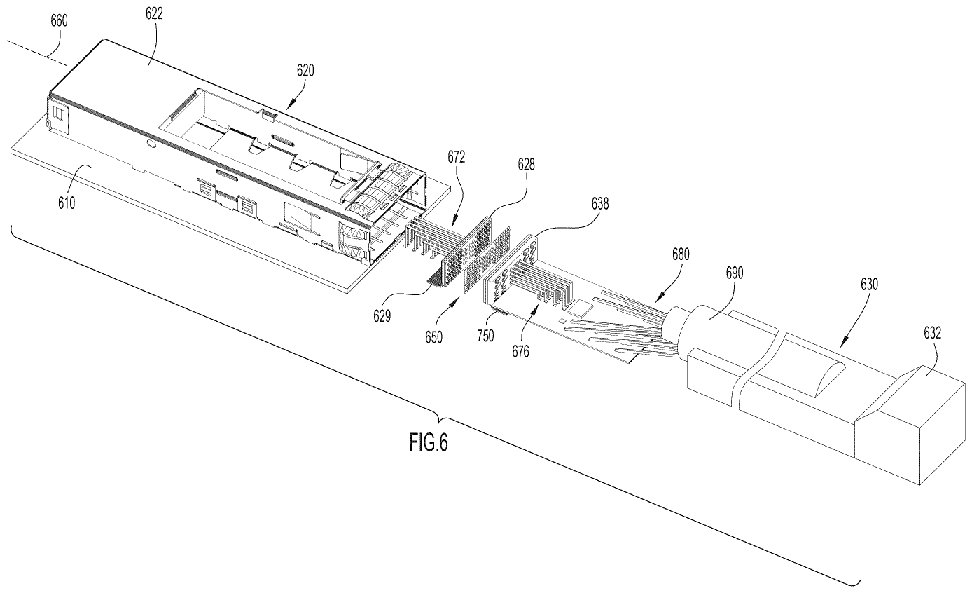

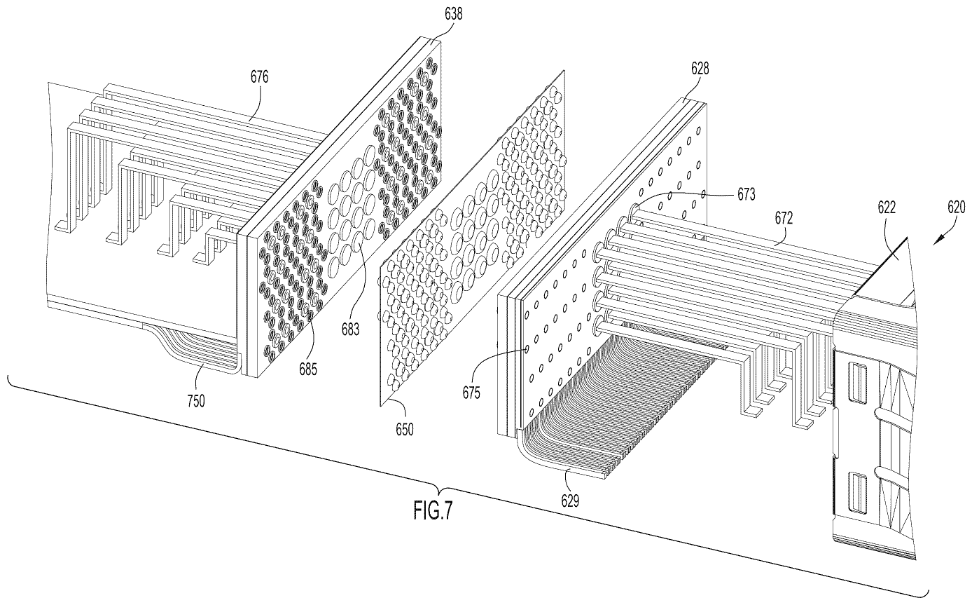

FIG. 6 is a partial exploded view of female and male components of a QSFP-DD Fiber Optic transceiver pin-less connector according to an example embodiment, and FIG. 7 is a diagram showing an elastomer interposer disposed between connection PCBs of female and male components of the QSFP-DD Fiber Optic transceiver pin-less connector.

As shown, a first connector portion 620 corresponds to a metal cage 622 or female component of a QSFP-DD Fiber Optic transceiver pin-less connector. First connector portion 620 is mounted to a printed circuit board (PCB) 610, which is mounted in a chassis (not shown). A second connector portion 630 corresponds to an insert or plug, which mates with first connector portion 620 by inserting second connector portion 630 along a travel axis 660 into first connector portion 620. Second connector portion 630 includes a connector cage 632 that is configured to receive a cable connector, in this can an optical fiber connector.

First connector portion 620 further includes a cage-side connection PCB 628 and second connector portion 630 includes a plug-side connection PCB 638. An elastomer interposer 650, including electrically conductive particles 350 dispersed therein (as explained previously in connection with FIG. 3) is sandwiched between cage-side connection PCB 628 and plug-side connection PCB 638.

Cage-side connection PCB 628 includes power pins 672 that terminate at power electrical contacts 673, and a flexible PCB 629, which is in electrical communication with PCB 610, supplies I/O signals to/from I/O electrical contacts 675. Power electrical contacts 673 and I/O electrical contacts 675 may be solder balls or metal exposed surfaces or pads on a side of cage-side connection PCB 628 facing elastomer interposer 650.

Plug-side connection PCB 638 includes power pins 676 that terminate at power electrical contacts 683. A flexible PCB 750 connects I/O signals to/from I/O electrical contacts 685. Power electrical contacts 683 and I/O electrical contacts 685 may be solder balls or metal pads that are exposed on a surface of a side of plug-side connection PCB 638 facing elastomer interposer 650. Notable in FIG. 7 (as compared to FIG. 2) is that plug-side connection PCB 638, and particularly I/O electrical contacts 685, are connected to the second connector portion 630 via a flexible PCB 750. That is, conductors of flexible PCB 750 are in respective communication with I/O conductors 680 that are connected to opto-electric coupler 690. Thus, in the case of the embodiments of FIGS. 6 and 7, both the cage-side connection PCB 628 and plug-side connection PCB 638 rely, at least partially, on flexible PCBs to transmit and receive I/O electrical signals. Flexible PCB 629 and flexible PCB 750 enable the cage-side connection PCB 628 and plug-side connection PCB 638 to be angled, e.g., 90 degrees, with respect to PCB 110 and thus properly face each other to sandwich elastomer interposer 650 therebetween.

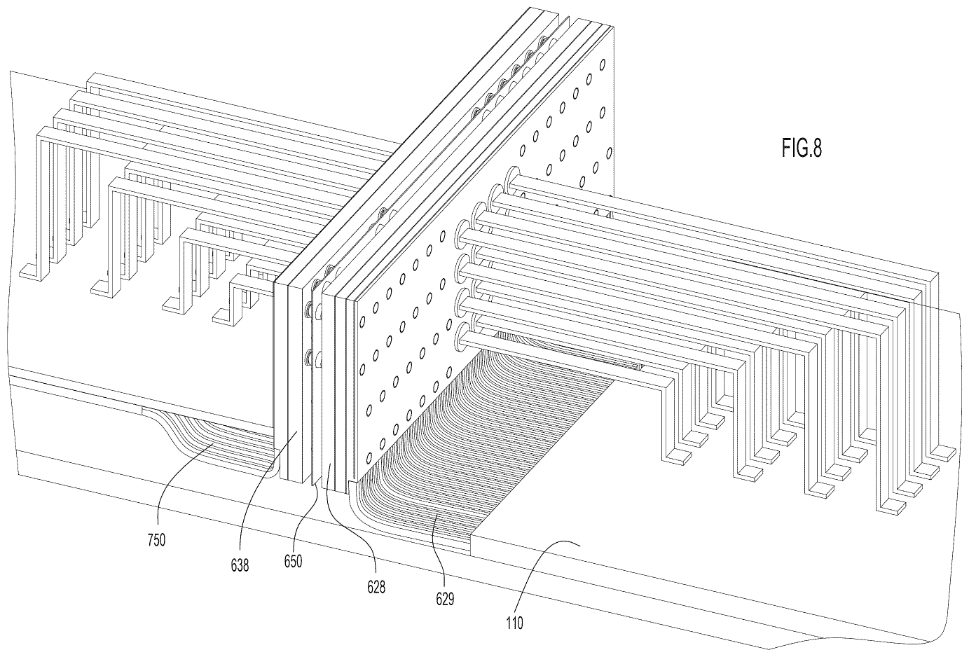

As with the embodiments illustrated in FIGS. 1-5, plug-side connection PCB 638 and cage-side connection PCB 628 are perpendicular to travel axis 660 so that planes of their opposing surfaces come together as shown in FIG. 3, and in FIG. 8, which shows the mated female and male components of the QSFP-DD Fiber Optic transceiver pin-less connector according to an example embodiment. Although not expressly shown, vias may be provided to connect power electrical contacts 673, 683 or I/O electrical contacts 675, 685 to opposing surfaces of plug-side connection PCB 638 and cage-side connection PCB 628, respectively.

The pin-less connector configuration shown in FIGS. 6-8 eliminates traditional pin/socket or pin/land connectors. As such, there are fewer or no small or sharp edged metal structures that can detrimentally act as antennas or radiators and cause spurious transmissions that can reduce signal integrity and increase channel crosstalk.

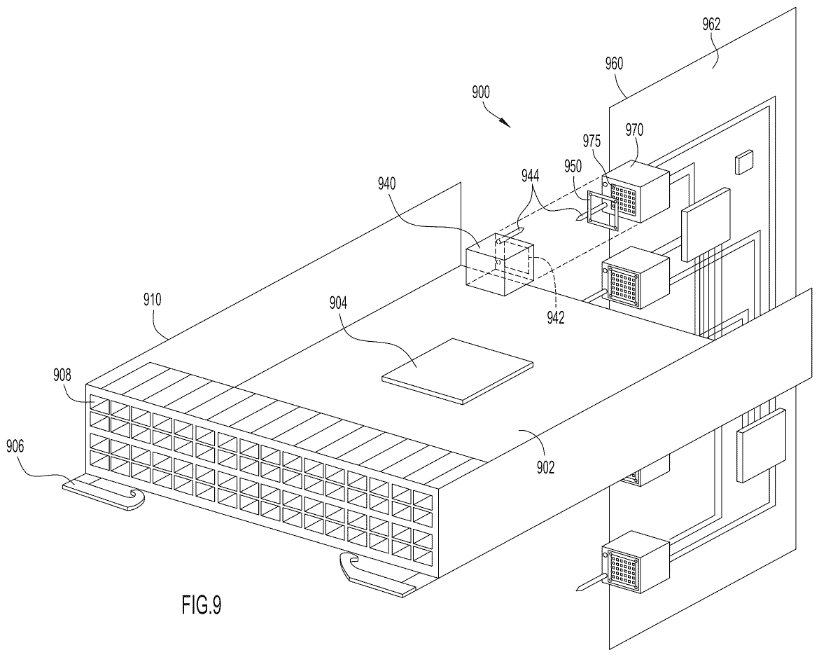

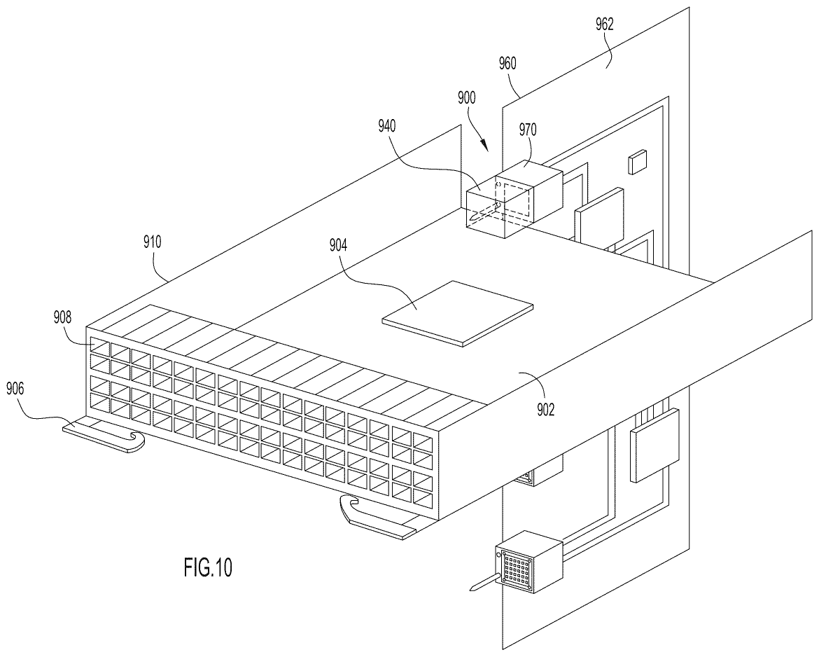

FIGS. 9 and 10 show the use of a pin-less connector 900 to connect a line card 910 with a fabric card 960 according to an example embodiment. FIG. 9 shows the line card 910 and the fabric card 960 separated from one another, while FIG. 10 shows the cards connected to one another via pin-less connector 900. In FIG. 9, line card 910 includes a PCB 902 with an Application Specific Integrated Circuit (ASIC) 904. Line card 910 further includes ejector levers 906 and a plurality of ports 908, perhaps consistent with a QSFP form factor. Line card 910 still further includes a back plane connector 940 having a plurality of exposed solder balls or metal pads 942 in a predetermined pattern and at least one guide pin 944.

Fabric card 960 includes a PCB 962 with associated electronic components, and a fabric card connector 970 having a plurality of exposed solder balls or metal pads 975, corresponding to the exposed solder balls or metal pads 942, and at least one guide pin 944. Guide pins 944 guide back plane connector 940 and fabric card connector 970 to align with one another as they are pushed together and mated. As with the embodiments described above, an elastomer interposer 950, like that described above in connection with FIG. 3, is disposed between exposed faces of backplane connector 940 and fabric card connector 970, and particularly the exposed solder balls or metal pads 942, 975. As such, when backplane connector 940 and fabric card connector 970 are brought or urged together, elastomer interposer 950 is sandwiched between the two opposing sides enabling connectivity between opposing pairs of exposed solder balls or metal pads 942, 975. This connection occurs when the elastomeric material of elastomer interposer 950 is broken down enabling conductive particles suspended therein to physically touch each other and provide a conductive path through elastomer interposer 950 for each such opposing pair of contacts.

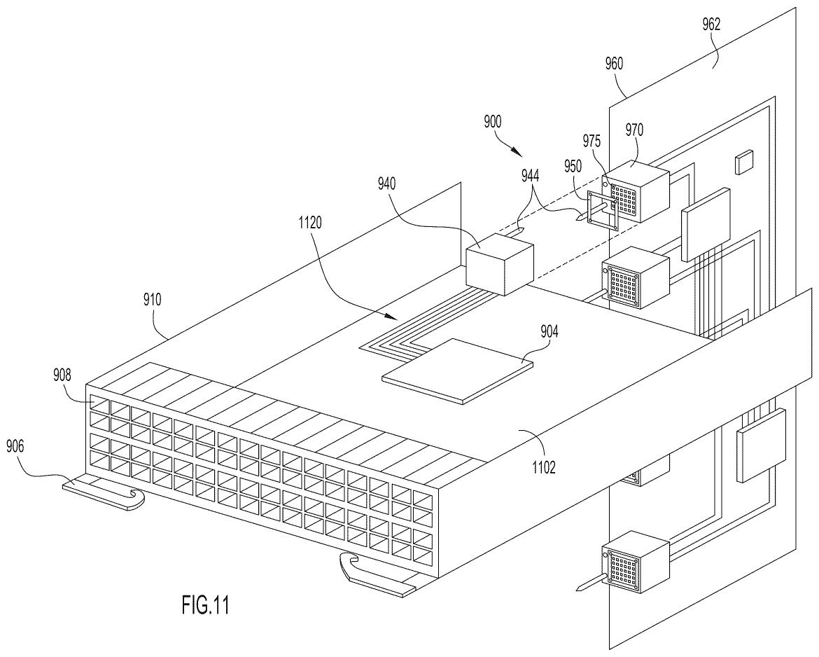

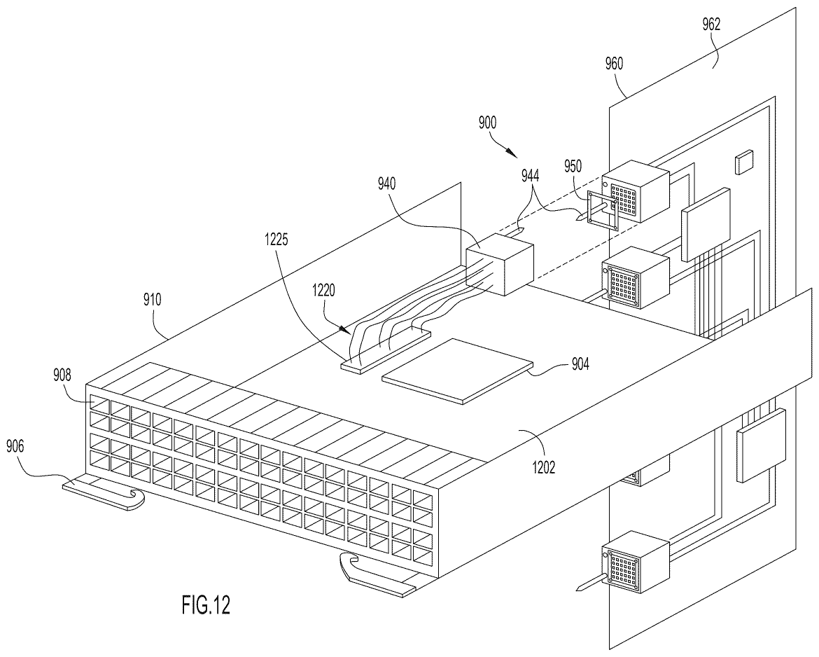

FIG. 11 shows pin-less connector 900 soldered to PCB 1102 and in communication with ASIC 904 via a plurality of PCB traces 1120. In another form, and as shown in FIG. 12, pin-less connector 900 is mounted to PCB 1102 and is in communication with ASIC 904 mounted on a PCB 1202 via a plurality of cables 1220 and connectors 1225.

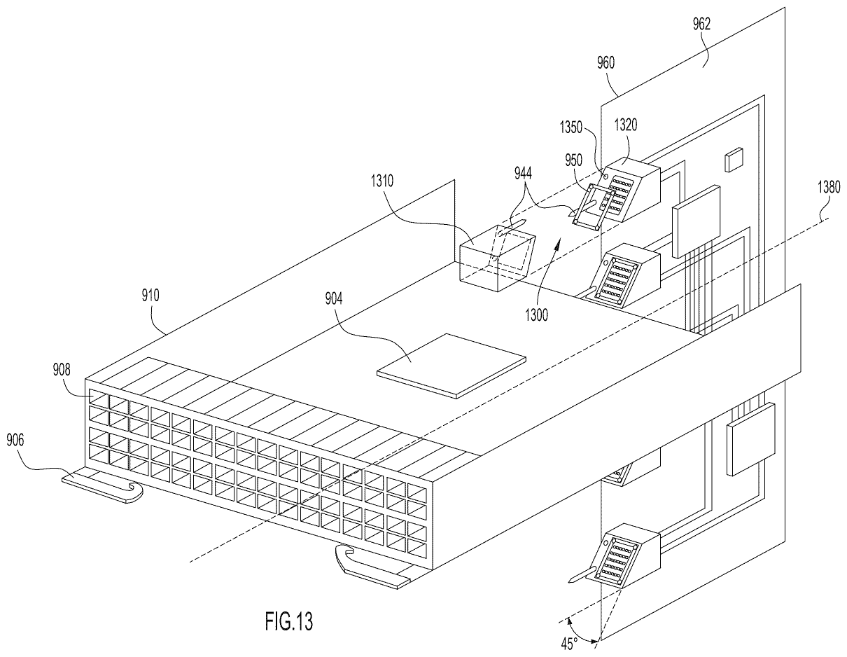

FIG. 13 shows a pin-less connector 1300 having off-angle mating faces according to an example embodiment. FIG. 13 is similar to FIG. 9 but, in the case of FIG. 13, pin-less connector 1300 comprises a back plane connector 1310 and a fabric card connector 1320 that have angled (non-perpendicular) faces 1350 as opposed to being oriented perpendicularly to a travel axis 1380. In one embodiment, the angled faces are set at an angle of 45 degrees to travel axis 1380.

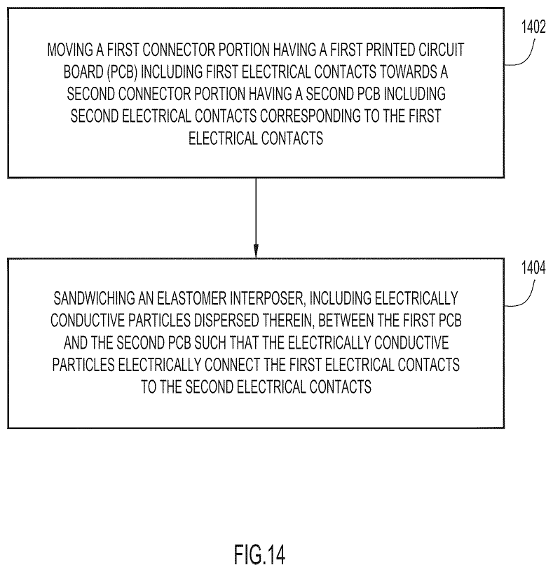

FIG. 14 is a flowchart depicting a series of operations to connect electrical components using a pin-less connector according to an example embodiment. At 1402, an operation includes moving a first connector portion having a first PCB including first electrical contacts toward a second connector portion having a second PCB including second electrical contacts corresponding to the first electrical contacts. And, at 1404, an operation includes sandwiching an elastomer interposer, including electrically conductive particles dispersed therein, between the first PCB and the second PCB to electrically connect the first electrical contacts to the second electrical contacts via the electrically conductive particles.

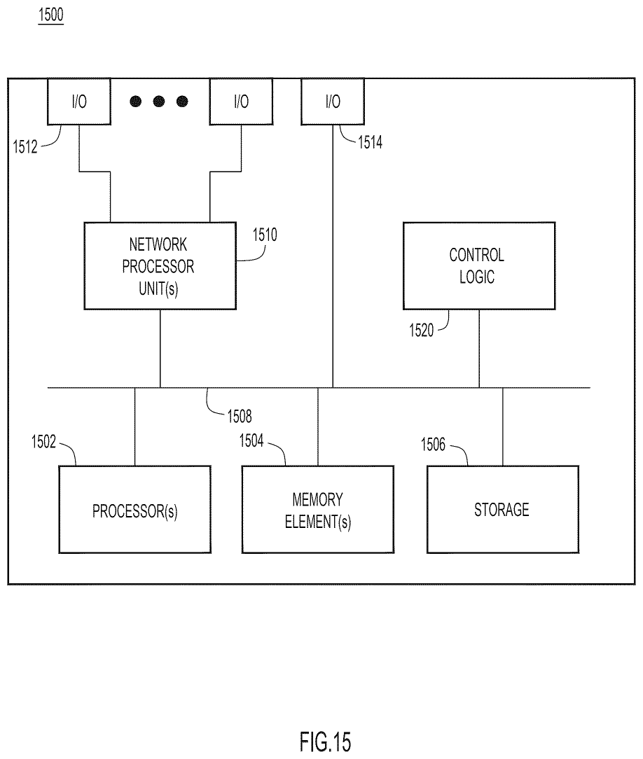

FIG. 15 is a block diagram of a computing device that may make use of the pin-less connector described herein and to perform techniques described herein, according to an example embodiment. In various embodiments, a computing device, such as computing device 1500 or any combination of computing devices 1500, may be configured as any entity/entities as discussed for the techniques depicted in connection with FIGS. 1-14 in order to perform operations of the various techniques discussed herein.

In at least one embodiment, the computing device 1500 may include one or more processor(s) 1502, one or more memory element(s) 1504, storage 1506, a bus 1508, one or more network processor unit(s) 1510 interconnected with one or more network input/output (I/O) interface(s) 1512 (which could make use of the pin-less connector), one or more I/O interface(s) 1514 (which could also make use of the pin-less connector), and control logic 1520. In various embodiments, instructions associated with logic for computing device 1500 can overlap in any manner and are not limited to the specific allocation of instructions and/or operations described herein.

In at least one embodiment, processor(s) 1502 is/are at least one hardware processor configured to execute various tasks, operations and/or functions for computing device 1500 as described herein according to software and/or instructions configured for computing device 1500. Processor(s) 1502 (e.g., a hardware processor) can execute any type of instructions associated with data to achieve the operations detailed herein. In one example, processor(s) 1502 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 1504 and/or storage 1506 is/are configured to store data, information, software, and/or instructions associated with computing device 1500, and/or logic configured for memory element(s) 1504 and/or storage 1506. For example, any logic described herein (e.g., control logic 1520) can, in various embodiments, be stored for computing device 1500 using any combination of memory element(s) 1504 and/or storage 1506. Note that in some embodiments, storage 1506 can be consolidated with memory element(s) 1504 (or vice versa) or can overlap/exist in any other suitable manner.

In at least one embodiment, bus 1508 can be configured as an interface that enables one or more elements of computing device 1500 to communicate in order to exchange information and/or data. Bus 1508 can be implemented with any architecture designed for passing control, data and/or information between processors, memory elements/storage, peripheral devices, and/or any other hardware and/or software components that may be configured for computing device 1500. In at least one embodiment, bus 1508 may be implemented as a fast kernel-hosted interconnect, potentially using shared memory between processes (e.g., logic), which can enable efficient communication paths between the processes.

In various embodiments, network processor unit(s) 1510 may enable communication between computing device 1500 and other systems, entities, etc., via network I/O interface(s) 1512 (wired and/or wireless) to facilitate operations discussed for various embodiments described herein. In various embodiments, network processor unit(s) 1510 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 1500 and other systems, entities, etc. to facilitate operations for various embodiments described herein. In various embodiments, network I/O interface(s) 1512 can be configured as one or more Ethernet port(s), Fibre Channel ports, any other I/O port(s), and/or antenna(s)/antenna array(s) now known or hereafter developed. Thus, the network processor unit(s) 1510 and/or network I/O interface(s) 1512 may include suitable interfaces for receiving, transmitting, and/or otherwise communicating data and/or information in a network environment.

I/O interface(s) 1514 allow for input and output of data and/or information with other entities that may be connected to computing device 1500. For example, I/O interface(s) 1514 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 1520 can include instructions that, when executed, cause processor(s) 1502 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 1520) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 1504 and/or storage 1506 can store data, software, code, instructions (e.g., processor instructions), logic, parameters, combinations thereof, and/or the like used for operations described herein. This includes memory element(s) 1504 and/or storage 1506 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi 6®), IEEE 802.16 (e.g., Worldwide Interoperability for Microwave Access (WiMAX)), Radio-Frequency Identification (RFID), Near Field Communication (NFC), Bluetooth™, mm. wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’nomenclature (e.g., one or more element(s)).

In sum, a connector is provided. The connector may include a first connector portion having a first printed circuit board (PCB) including first electrical contacts, a second connector portion having a second PCB including second electrical contacts in an arrangement corresponding to an arrangement of the first electrical contacts, and an elastomer interposer disposed between the first PCB and the second PCB, the elastomer interposer including electrically conductive particles dispersed therein that electrically connect the first electrical contacts to the second electrical contacts.

The first electrical contacts and the second electrical contacts may be solder balls.

The first electrical contacts and the second electrical contacts may be metal pads.

The first PCB and the second PCB may be arranged in parallel planes that are perpendicular to an axis along which one of the first connector portion and the second connector portion travels to mate the first connector portion and the second connector portion.

The first PCB and the second PCB may be arranged in parallel planes that are set at a non-perpendicular angle with respect to an axis along which one of the first connector portion and the second connector portion travels to mate the first connector portion and the second connector portion.

The first electrical contacts and the second electrical contacts may be pin-less.

The first PCB may be in electrical communication with the first connector portion via a flexible printed circuit board.

The second PCB may be in electrical communication with the second connector portion via a flexible printed circuit board.

The connector may have a form factor of a Quad Small Form-factor Pluggable (QSFP) connector.

The connector may be configured to connect a line card to a fabric card.

In another embodiment, a connector may include a first connector portion having a first set of pin-less electrical contacts, a second connector portion configured to mate with the first connector portion and having a second set of pin-less electrical contacts in an arrangement corresponding to an arrangement of the first set of pin-less electrical contacts, and an elastomer interposer configured to be compressed between the first set of pin-less electrical contacts and the second set of pin-less electrical contacts, the elastomer interposer including electrically conductive particles dispersed therein that establish electrical connection between the first set of pin-less electrical contacts and the second set of pin-less electrical contacts.

The first set of pin-less electrical contacts and the second set of pin-less electrical contacts may be solder balls.

The first set of pin-less electrical contacts and the second set of pin-less electrical contacts may be metal pads.

The first set of pin-less electrical contacts may be arranged on a first printed circuit board (PCB) and the second set of pin-less electrical contacts may be arranged on a second PCB, and the first PCB and the second PCB are arranged in parallel planes that are perpendicular to an axis along which one of the first connector portion and the second connector portion travels to mate the first connector portion and the second connector portion.

The first set of pin-less electrical contacts may be arranged on a first printed circuit board (PCB) and the second set of pin-less electrical contacts may be arranged on a second PCB, and the first PCB and the second PCB may be arranged in parallel planes that are set at a non-perpendicular angle with respect to an axis along which one of the first connector portion and the second connector portion travels to mate the first connector portion and the second connector portion.

The first set of pin-less electrical contacts may be in electrical communication with the first connector portion via a flexible printed circuit board.

The second set of pin-less electrical contacts may be in electrical communication with the second connector portion via a flexible printed circuit board.

In yet another embodiment, a method may include moving a first connector portion having a first printed circuit board (PCB) including first electrical contacts towards a second connector portion having a second PCB including second electrical contacts corresponding to the first electrical contacts, and sandwiching an elastomer interposer, including electrically conductive particles dispersed therein, between the first PCB and the second PCB such that the electrically conductive particles electrically connect the first electrical contacts to the second electrical contacts.

In the method, the first connector portion and the second connector portion may be portions of a Quad Small Form-factor Pluggable (QSFP) connector.

In the method, the first connector portion may be a back plane connector and the second connector portion may be a fabric card connector.

Each example embodiment disclosed herein has been included to present one or more different features. However, all disclosed example embodiments are designed to work together as part of a single larger system or method. This disclosure explicitly envisions compound embodiments that combine multiple previously discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A connector comprising:
a first connector portion having a first printed circuit board (PCB) including first electrical contacts;
a second connector portion having a second PCB including second electrical contacts in an arrangement corresponding to an arrangement of the first electrical contacts; and
an elastomer interposer disposed between the first PCB and the second PCB, the elastomer interposer including electrically conductive particles dispersed therein that electrically connect the first electrical contacts to the second electrical contacts.

2. The connector of claim 1, wherein the first electrical contacts and the second electrical contacts comprise solder balls.

3. The connector of claim 1, wherein the first electrical contacts and the second electrical contacts comprise metal pads.

4. The connector of claim 1, wherein the first PCB and the second PCB are arranged in parallel planes that are perpendicular to an axis along which one of the first connector portion and the second connector portion travels to mate the first connector portion and the second connector portion.

5. The connector of claim 1, wherein the first PCB and the second PCB are arranged in parallel planes that are set at a non-perpendicular angle with respect to an axis along which one of the first connector portion and the second connector portion travels to mate the first connector portion and the second connector portion.

6. The connector of claim 1, wherein the first electrical contacts and the second electrical contacts are pin-less.

7. The connector of claim 1, wherein the first PCB is in electrical communication with the first connector portion via a flexible printed circuit board.

8. The connector of claim 7, wherein the second PCB is in electrical communication with the second connector portion via a flexible printed circuit board.

9. The connector of claim 1, wherein the connector has a form factor of a Quad Small Form-factor Pluggable (QSFP) connector.

10. The connector of claim 1, wherein the connector is configured to connect a line card to a fabric card.

11. A connector comprising:
a first connector portion having a first set of pin-less electrical contacts;
a second connector portion configured to mate with the first connector portion and having a second set of pin-less electrical contacts in an arrangement corresponding to an arrangement of the first set of pin-less electrical contacts; and
an elastomer interposer configured to be compressed between the first set of pin-less electrical contacts and the second set of pin-less electrical contacts, the elastomer interposer including electrically conductive particles dispersed therein that establish electrical connection between the first set of pin-less electrical contacts and the second set of pin-less electrical contacts.

12. The connector of claim 11, wherein the first set of pin-less electrical contacts and the second set of pin-less electrical contacts comprise solder balls.

13. The connector of claim 11, wherein the first set of pin-less electrical contacts and the second set of pin-less electrical contacts comprise metal pads.

14. The connector of claim 11, wherein the first set of pin-less electrical contacts are arranged on a first printed circuit board (PCB) and the second set of pin-less electrical contacts are arranged on a second PCB, and the first PCB and the second PCB are arranged in parallel planes that are perpendicular to an axis along which one of the first connector portion and the second connector portion travels to mate the first connector portion and the second connector portion.

15. The connector of claim 11, wherein the first set of pin-less electrical contacts are arranged on a first printed circuit board (PCB) and the second set of pin-less electrical contacts are arranged on a second PCB, and the first PCB and the second PCB are arranged in parallel planes that are set at a non-perpendicular angle with respect to an axis along which one of the first connector portion and the second connector portion travels to mate the first connector portion and the second connector portion.

16. The connector of claim 11, wherein the first set of pin-less electrical contacts is in electrical communication with the first connector portion via a flexible printed circuit board.

17. The connector of claim 16, wherein the second set of pin-less electrical contacts is in electrical communication with the second connector portion via a flexible printed circuit board.

18. A method comprising:
moving a first connector portion having a first printed circuit board (PCB) including first electrical contacts towards a second connector portion having a second PCB including second electrical contacts corresponding to the first electrical contacts; and
sandwiching an elastomer interposer, including electrically conductive particles dispersed therein, between the first PCB and the second PCB such that the electrically conductive particles electrically connect the first electrical contacts to the second electrical contacts.

19. The method of claim 18, wherein the first connector portion and the second connector portion are portions of a Quad Small Form-factor Pluggable (QSFP) connector.

20. The method of claim 18, wherein the first connector portion is a back plane connector and the second connector portion is a fabric card connector.
